(19) United States
(12) Patent Application Publication
(10) Pub. No.: US 2026/0317851 A1
(43) Pub. Date: Oct. 15, 2026

(54) METHODS FOR LOW-CARBON PREPARATION OF BLAST FURNACE BURDEN FROM SINTER RETURN ORE

(71) Applicant: CENTRAL SOUTH UNIVERSITY, Changsha (CN)

(72) Inventors: Zhiyun JI, Changsha (CN); Xiaohui FAN, Changsha (CN); Min GAN, Changsha (CN); Xiaolong WANG, Changsha (CN); Shengxuan FAN, Changsha (CN); Zengqing SUN, Changsha (CN); Xuling CHEN, Changsha (CN); Jiaming LYU, Changsha (CN); Jiasheng LI, Changsha (CN); Xiaoxian HUANG, Changsha (CN); Zhenxiang FENG, Changsha (CN); Lishun YUAN, Changsha (CN)

(73) Assignee: CENTRAL SOUTH UNIVERSITY, Changsha (CN)

(21) Appl. No.: 19/463,070

(22) Filed: Jan. 28, 2026

(30) Foreign Application Priority Data
Apr. 9, 2025 (CN) 202510435633.3

(51) Int. Cl. C22B 1/242

(52) U.S. Cl. CPC C22B 1/242

(57) ABSTRACT

Provided is a method for low-carbon preparation of a blast furnace burden from a sinter return ore. The method includes: mixing the sinter return ore with an undersize material from a blast furnace lump ore, a combustible organic waste powder, a fine-sized metallized material, an iron-containing dust, a binder, and water; forming a wet briquette by high-pressure double-roller forming; and subjecting the wet briquette to low-temperature drying and consolidation to obtain a cold briquette. In terms of mass percentage, a combined mass of the sinter return ore and the undersize material from the blast furnace lump ore accounts for 92.5-93.5%, the combustible organic waste powder accounts for 5-6%, the fine-sized metallized material accounts for 1-2%, and the iron-containing dust accounts for 0.5-1.5%. The fine-sized metallized material includes an undersize material from metallized pellets obtained from a direct reduction process or an indirect reduction process.

### CROSS-REFERENCE TO RELATED APPLICATIONS

This application claims priority to Chinese Patent Application No. 202510435633.3, filed on Apr. 9, 2025, the contents of which are hereby incorporated by reference.

### TECHNICAL FIELD

The present disclosure generally relates to a field of iron and steel metallurgy, and in particular, to a method for low-carbon preparation of a blast furnace burden from a sinter return ore.

### BACKGROUND

The iron and steel industry is one of the main sources of global carbon emissions, especially the blast furnace-converter long-process smelting process, the carbon emissions of which account for a considerable proportion of global manufacturing carbon emissions. Currently, as a key industry, the iron and steel industry faces severe challenges in reducing carbon emissions, optimizing energy utilization, and improving resource recycling efficiency. Therefore, researching and developing low-carbon and efficient blast furnace burden preparation methods to reduce carbon emissions in the ironmaking process has become an important development direction in iron and steel metallurgy technology.

In traditional ironmaking processes, a blast furnace mainly uses iron-containing burdens such as sinter, pellets, and lump ore. Among them, the sinter accounts for a large proportion of the blast furnace burden due to its good metallurgical performance and economy. However, the carbon emissions of the sintering process are high, mainly from fuel combustion (e.g., coke breeze, pulverized coal).

In the sintering and blast furnace smelting processes, a large amount of return ore (e.g., sinter return ore, blast furnace return ore) is generated. The return ore is mainly composed of incompletely reacted sintering materials, iron ore, iron-containing dust-and-sludge, or the like, and has a high iron content (generally 40-60%). Currently, most of the return ore is directly returned to the sintering process for reuse. In one respect, reusing the return ore consumes additional fuel, electricity, and manpower. The energy consumption of the sintering process reaches 48.50 kgce per ton, and the thermal efficiency of recycling sintering of the return ore is only 20-30%, resulting in an increase in comprehensive energy consumption by more than 70%. In another respect, due to the powdery features of the return ore, excessive addition affects the permeability of the sintering material, thereby reducing the strength and output of the sinter. Therefore, how to efficiently and low-carbon utilize sinter return ore has become an urgent problem for iron and steel enterprises.

Therefore, it is necessary to provide a method for low-carbon preparation of a blast furnace burden from a sinter return ore to reduce the use of sinter, optimize the burden structure, and reduce carbon emissions of the blast furnace.

### SUMMARY

One or more embodiments of the present disclosure provide a method for low-carbon preparation of a blast furnace burden from a sinter return ore. The method includes: mixing the sinter return ore with an undersize material from a blast furnace lump ore, a combustible organic waste powder, a fine-sized metallized material, an iron-containing dust, a binder, and water, forming a wet briquette by high-pressure double-roller forming, and subjecting the wet briquette to low-temperature drying and consolidation to obtain a cold briquette; wherein, in a mass percentage, a combined mass of the sinter return ore and the undersize material from the blast furnace lump ore accounts for 92.5-93.5%, the combustible organic waste powder accounts for 5-6%, the fine-sized metallized material accounts for 1-2%, and the iron-containing dust accounts for 0.5-1.5%; wherein the fine-sized metallized material includes an undersize material from metallized pellets obtained from a direct reduction process or an indirect reduction process.

### DETAILED DESCRIPTION

To facilitate understanding of the present disclosure, the present disclosure is described in a more comprehensive and detailed manner below in combination with preferred embodiments. However, the protection scope of the present disclosure is not limited to the following specific embodiments.

Unless otherwise defined, all professional terms used below have the same meanings as those usually understood by a person skilled in the art. The patent terms used in the present disclosure are only for the purpose of describing specific embodiments and are not intended to limit the protection scope of the present disclosure.

Unless otherwise specified, various reagents and raw materials used in the present disclosure are commercially available products or products that can be prepared by known manners.

A sinter (i.e., sintered iron ore) is a common raw material used in a blast furnace ironmaking process. The sinter may be prepared industrially through a sintering process. For example, iron ore, fuel (e.g., coke breeze, pulverized coal), and flux (e.g., limestone, dolomite) are mixed to form a pre-sintering material. Subsequently, ignition sintering is performed to cause the pre-sintering material to react at a high temperature to form a liquid phase melt. The liquid phase melt bonds iron-containing particles into a porous sinter cake. The sinter cake is crushed and screened to obtain a finished sinter.

However, due to local differences in a particle size distribution of a sintering material, a sintering temperature, an oxygen content, etc., a portion of the pre-sintering material may fail to be fully bonded. When the finished sinter is screened, sinter slag (or referred to as undersize material) below a screen mesh cannot be used for blast furnace ironmaking due to an excessively small particle size. The pre-sintering material that fails to be fully bonded and the screened sinter slag, are collectively referred to as sinter return ore.

Currently, a main recycling manner for the sinter return ore is a secondary sintering process. A portion of the pre-sintering material is added to the sinter return ore to prepare the finished sinter through secondary ignition sintering. The secondary sintering process not only has huge carbon emissions but also has low energy utilization efficiency.

Therefore, the present disclosure provides a method for low-carbon preparation of a blast furnace burden from a sinter return ore. The method uses the sinter return ore as a main raw material, adjusts a raw material composition by adding undersize material from a blast furnace lump ore, a combustible organic waste powder, a fine-sized metallized material, an iron-containing dust, etc., and adds a binder to perform high-pressure forming and low-temperature drying and consolidation to prepare a sinter return ore cold briquette that meets performance requirements of the blast furnace burden. The method can utilize the sinter return ore, the fine-sized metallized material, and the combustible organic waste resource in a low-carbon and efficient manner. Compared with directly returning the sinter return ore to the sintering process for treatment, the method has features such as a simple process, low energy consumption, and low carbon emissions. The method can also solve problems that still exist in the sinter return ore cold briquette process, such as a high price of the binder, a high content of harmful elements, and a long consolidation time of a formed briquette, thus promoting large-scale application.

To achieve the above technical objective, the present disclosure provides a method for low-carbon preparation of a blast furnace burden from a sinter return ore. The method includes: mixing the sinter return ore with the undersize material from the blast furnace lump ore, the combustible organic waste powder, the fine-sized metallized material, the iron-containing dust, the binder, and water, forming a wet briquette by high-pressure double-roller forming, and subjecting the wet briquette to low-temperature drying and consolidation to obtain the cold briquette; wherein, in a mass percentage, a combined mass of the sinter return ore and the undersize material from the blast furnace lump ore accounts for 92.5-93.5%, the combustible organic waste powder accounts for 5-6%, the fine-sized metallized material accounts for 1-2%, and the iron-containing dust accounts for 0.5-1.5%; wherein the fine-sized metallized material includes an undersize material from metallized pellets obtained from a direct reduction process or an indirect reduction process.

The undersize material from the blast furnace lump ore refers to fine particles that pass through a screen mesh, during a screening process of a finished sinter, which are usually generated during crushing and screening of the finished sinter. The undersize material refers to a material with a particle size smaller than a screen mesh aperture and passing through a screen mesh. The undersize material corresponds to an oversize material remaining on a screen surface in a screening process.

In some embodiments, the particle size of the undersize material from the blast furnace lump ore needs to be controlled within an appropriate range. If the particle size of the undersize material from the blast furnace lump ore is too large, a local stress concentration may occur during forming. The local stress concentration may cause a micro-crack network to form inside the briquette. The micro-crack network significantly reduces a strength of the briquette.

In some embodiments, the particle size of the undersize material from the blast furnace lump ore may be determined according to an actual application scenario and requirement.

In some embodiments, the particle size of the undersize material from the blast furnace lump ore satisfies that a fraction of particles smaller than 5 mm is not less than 90 wt. %.

In some embodiments, the fraction of particles smaller than 5 mm in the undersize material from the blast furnace lump ore may be one of 90 wt. %, 92 wt. %, 94 wt. %, 96 wt. %, 98 wt. %, or 100 wt. %.

In some embodiments, the fraction of particles smaller than 5 mm in the undersize material from the blast furnace lump ore may be in a range of 90-92 wt. %, 92-94 wt. %, 94-96 wt. %, 96-98 wt. %, 98-100 wt. %, 90-94 wt. %, 92-96 wt. %, 94-98 wt. %, or 96-100 wt. %.

The combustible organic waste powder is a powder, obtained by mechanically crushing combustible organic solid waste. The term “combustible” indicates that the organic waste powder contains a certain calorific value and is able to provide heat by burning.

A type of the combustible organic waste may be determined based on an actual need. For example, the combustible organic waste includes waste resin, waste leather, waste fabric, etc.

In some embodiments, the combustible organic waste powder includes at least one of waste biomass, waste rubber, and waste plastic.

The waste biomass is organic waste derived from organisms such as plants, animals, or microorganisms. The waste biomass may include straw, sawdust, bagasse, Chinese herb-extraction residues, etc.

In some embodiments, a material of the waste rubber includes, but is not limited to, natural rubber waste, chloroprene rubber waste, nitrile rubber waste, etc. A material of the waste plastic includes, but is not limited to, polyethylene (PE), polypropylene (PP), polyvinyl chloride (PVC), polystyrene (PS), etc.

In some embodiments, the waste biomass includes at least one of sawdust, bark, rice husk, and corn straw. The waste rubber includes at least one of a scrap tire, a rubber sealing strip, a rubber hose, an industrial rubber product waste, and a rubber processing scrap. The waste plastic includes at least one of a PE packaging film, a PP container, a PVC pipe, a polyester (PET) bottle, a PS foam, and an agricultural film.

In some embodiments, by specifying the types of waste biomass, waste rubber, and waste plastic, the selected wastes have extensive sources, stable supply channels, and significantly lower costs than traditional fossil fuels, thus effectively reducing the preparation cost of blast furnace burden and enhancing market competitiveness.

In some embodiments, the particle size of the combustible organic waste powder may be determined according to the actual application scenario and requirement. For example, the particle size of the combustible organic waste powder satisfies that a fraction of particles smaller than 1 mm is not lower than 93 wt. %.

In some embodiments, the fraction of particles smaller than 1 mm of the combustible organic waste powder may be one of 93 wt. %, 94 wt. %, 95 wt. %, 96 wt. %, 97 wt. %, 98 wt. %, 99 wt. %, or 100 wt. %.

In some embodiments, the fraction of particles smaller than 1 mm of the combustible organic waste powder may be in a range of 93-95 wt. %, 94-96 wt. %, 95-97 wt. %, 96-98 wt. %, 97-99 wt. %, 98-100 wt. %, 93-96 wt. %, 94-97 wt. %, 95-98 wt. %, 96-99 wt. %, or 97-100 wt. %.

In some embodiments, a calorific value of the combustible organic waste powder is not less than 10 MJ/kg.

In some embodiments, the calorific value of the combustible organic waste powder may be one of ≥10 MJ/kg, ≥15 MJ/kg, ≥20 MJ/kg, ≥25 MJ/kg, ≥30 MJ/kg, ≥35 MJ/kg, or ≥40 MJ/kg.

In some embodiments, the calorific value of the combustible organic waste powder may be one of 10 MJ/kg, 12 MJ/kg, 14 MJ/kg, 16 MJ/kg, 18 MJ/kg, or 20 MJ/kg.

In some embodiments, the calorific value of the combustible organic waste powder may be in a range of 10-12 MJ/kg, 12-14 MJ/kg, 14-16 MJ/kg, 16-18 MJ/kg, 18-20 MJ/kg, 10-14 MJ/kg, 12-16 MJ/kg, 14-18 MJ/kg, or 16-20 MJ/kg.

In some embodiments, an excessively large particle size of the combustible organic waste powder may hinder bonding between particles of other materials, resulting in loosely structured briquettes. Furthermore, during a cold pressing process, large particles of biomass are unable to be sufficiently compressed, resulting in voids inside the briquette and reducing the compressive strength. By setting the proportion of the combustible organic waste powder having a particle size of less than 1 mm to be not less than 93 wt. %, the combustible organic waste powder can have a suitable particle size.

The fine-sized metallized material is powder and debris obtained by screening metallized pellets, and main components of the fine-sized metallized material are reduced powdery metallic iron, residual small counts of iron oxides (e.g., FeO, Fe₂O₃, Fe₃O₄), and slag. The term “fine-sized” means that the metallic iron contained in the metallized material exists in the form of fine particles, e.g., metallic iron microcrystals, spongy metallic iron, or the like.

In some embodiments, the fine-sized metallized material includes undersize material from metallized pellets obtained by the direct reduction process or the indirect reduction process.

In some embodiments, the fine-sized metallized material may be an undersize material from a gas-based shaft furnace reduction product, an undersize material from a rotary hearth furnace reduction product, an undersize material from a coal-based rotary kiln reduction product, or an undersize material from a coal-based shaft furnace reduction product, etc.

The gas-based shaft furnace, the rotary hearth furnace, the coal-based rotary kiln, and the coal-based shaft furnace are all reduction equipment in the metallurgical field used to prepare metallized pellets (or referred to as reduction products).

The gas-based shaft furnace is a reduction equipment with a vertical structure. A reducing agent of the gas-based shaft furnace is a gaseous reducing agent, a pre-sintering material and the reducing gas flow counter-currently, and the reducing gas indirectly reduces the pre-sintering material. The gas-based shaft furnace exhibits minimal temperature fluctuations, and maintains a stable yield of metallic iron. Powder and debris obtained by screening a reduction product of the gas-based shaft furnace, are referred to as the undersize material from the gas-based shaft furnace reduction product.

The rotary hearth furnace is a reduction equipment with a rotatable furnace bottom. The pre-sintering material enters a slowly rotating furnace bottom, and sequentially passes through a preheating zone, a high-temperature reduction zone, and a cooling zone, ultimately being reduced to metallized pellets. Rapid reduction reaction rates and short reduction cycles, enable the rotary hearth furnace to support industrial continuous production. Powder and debris obtained by screening a reduction product of the rotary hearth furnace are referred to as the undersize material from the rotary hearth furnace reduction product.

The coal-based rotary kiln is a reduction equipment with a continuously inclined and rotating kiln body. The kiln body of the coal-based rotary kiln is in an inclined and rotating state, solid coal is used as the reducing agent, the pre-sintering material and the solid coal roll and rotate with the kiln body inside the kiln, heat is supplied by combustion of the coal and the reduction reaction occurs, and metallized pellets are obtained by direct reduction. The coal-based rotary kiln is suitable for pre-sintering materials with a wide particle size distribution. Powder and debris obtained by screening a reduction product of the coal-based rotary kiln are referred to as the undersize material from the coal-based rotary kiln reduction product.

The coal-based shaft furnace is a reduction equipment with a vertical structure. The coal-based shaft furnace is similar to the gas-based shaft furnace, differing in that the gas-based shaft furnace uses the gaseous reducing agent, whereas the coal-based shaft furnace employs the solid coal as the reducing agent. The solid coal and metallized pellets are fully mixed and charged into the coal-based shaft furnace, heat is supplied by combustion of the coal and the reduction reaction occurs, and metallized pellets are obtained by direct reduction. The coal-based shaft furnace is suitable for large-scale production. Powder and debris obtained by screening a reduction product of the coal-based shaft furnace, are referred to as the undersize material from the coal-based shaft furnace reduction product.

In some embodiments, the fine-sized metallized material may also include undersize material from reduction products of other reduction equipment, such as stepwise reduction furnaces and annular calcining furnaces.

In some embodiments, by setting the fine-sized metallized material to be at least one of the undersize material from the gas-based shaft furnace reduction product, the undersize material from the rotary hearth furnace reduction product, the undersize material from the coal-based rotary kiln reduction product, and the undersize material from the coal-based shaft furnace reduction product, the four types of undersize material are all waste generated during iron and steel metallurgical processes. Using the four types of undersize material as raw materials for a pre-sintering material, can reduce solid waste accumulation and treatment costs, and achieve efficient resource recycling.

In some embodiments, a particle size of the fine-sized metallized material may be determined according to actual application scenarios and requirements. For example, the fraction of particles smaller than 5 mm of the fine-sized metallized material is not less than 90 wt. %.

In some embodiments, the fraction of particles smaller than 5 mm of the fine-sized metallized material may be one of 90 wt. %, 92 wt. %, 94 wt. %, 96 wt. %, 98 wt. %, or 100 wt. %.

In some embodiments, a particle size of the fine-sized metallized material satisfies that the fraction of particles smaller than 5 mm may be in a range of 90-98 wt. %, 92-100 wt. %, 90-94 wt. %, 92-96 wt. %, 94-98 wt. %, or 96-100 wt. %.

In some embodiments, an MFe content in the fine-sized metallized material is not less than 50 wt. %.

The term “MFe content” refers to the metallic iron content in the fine-sized metallized material. In some embodiments, the MFe content in the fine-sized metallized material may be one of 50 wt. %, 55 wt. %, 60 wt. %, 67 wt. %, 70 wt. %, 77 wt. %, 80 wt. %, 90 wt. %, or 100 wt. %.

In some embodiments, the MFe content in the fine-sized metallized material may be in a range of 50 wt. %-67 wt. %, 50 wt. %-70 wt. %, 55 wt. %-70 wt. %, 55 wt. %-77 wt. %, 60 wt. %-77 wt. %, 67 wt. %-80 wt. %, 70 wt. %-90 wt. %, 77 wt. %-100 wt. %, 50 wt. %-80 wt. %, or 55 wt. %-80 wt. %.

In some embodiments, although the fine-sized metallized material has good plasticity and ductility, if the particle size is too large, it is difficult to distribute uniformly inside a wet briquette, thereby affecting strength and quality stability of the wet briquette. Setting the particle size to satisfy that the fraction of particles smaller than 5 mm is not less than 90 wt. % helps ensure structural strength of the wet briquette. An MFe content being too low affects plasticity and ductility, thereby affecting briquette strength. Setting the MFe content to be not less than 50 wt. % helps guarantee elasticity and ductility of the wet briquette.

The iron-containing dust is iron-containing dust generated during iron and steel metallurgy, typically generated in processes such as sintering, blast furnace ironmaking, converter steelmaking, and cold rolling, and is present in forms such as dust, sludge, and oxidized debris.

In some embodiments, a type of the iron-containing dust may be determined according to the actual application scenario and requirements. For example, the iron-containing dust includes iron oxide powder on a steel surface, cutting dust from a steel processing process, grinding dust, or the like.

In some embodiments, the iron-containing dust includes at least one of a sinter dedusting ash, a blast furnace secondary dedusting ash, a converter dust-and-sludge, a casthouse dust, and a cold rolling sludge.

The sinter dedusting ash is an iron-containing dust generated during iron and steel sintering, primarily consisting of airborne particles from the sintering material undergoing high-temperature reactions. The sinter dedusting ash may be collected by a dust removal system of equipment, such as a sintering machine and a ring cooler.

The blast furnace secondary dedusting ash is iron-containing dust generated during blast furnace ironmaking, primarily consisting of fine particles carried in blast furnace gas. The blast furnace secondary dedusting ash may be collected by a dust removal system of the blast furnace.

The converter dust-and-sludge refers to iron-containing dust and sludge generated during converter steelmaking, primarily consisting of smoke dust and slag particles generated during a converter blowing process. The converter dust-and-sludge may be collected by a dust removal system of the converter.

The casthouse dust refers to iron-containing dust generated during blast furnace tapping, primarily consisting of smoke dust generated when molten iron inside a furnace is discharged from the blast furnace. The casthouse dust may be collected by the dust removal system near a tap hole.

The cold rolling sludge refers to iron-containing sludge generated during steel cold rolling, primarily consisting of iron-containing substances generated in cold rolling processes (e.g., pickling, rolling), and the cold rolling sludge may be collected by a cold rolling wastewater treatment system.

In some embodiments, a particle size of the iron-containing dust satisfies that a fraction of particles smaller than 1 mm is not less than 90 wt. %, and a chloride content in the iron-containing dust is <0.75 wt. %.

In some embodiments, the fraction of particles smaller than 1 mm of the iron-containing dust may be one of 90 wt. %, 91 wt. %, 92 wt. %, 93 wt. %, 94 wt. %, 95 wt. %, 96 wt. %, 97 wt. %, 98 wt. %, 99 wt. %, or 100 wt. %.

In some embodiments, the fraction of particles smaller than 1 mm of the iron-containing dust may be in a range of 90-94 wt. %, 90-95 wt. %, 90-97 wt. %, 90-100 wt. %, 94-97 wt. %, 94-100 wt. %, 97-100 wt. %, or 97-98 wt. %.

In some embodiments, the chloride content in the iron-containing dust may be one of 0 wt. %, 0.12 wt. %, 0.25 wt. %, 0.35 wt. %, 0.5 wt. %, 0.66 wt. %, or 0.75 wt. %.

In some embodiments, the chloride content in the iron-containing dust may be in a range of 0-0.5 wt. %, 0.5-0.75 wt. %, 0.5-0.70 wt. %, 0.66-0.70 wt. %, 0.66-0.75 wt. %, 0-0.66 wt. %, 0.70-0.75 wt. %, 0.35-0.70 wt. %, 0.5-0.66 wt. %, or 0.35-0.75 wt. %.

In some embodiments, a function of the iron-containing dust is to fill pores between large particles. The particle size of the iron-containing dust should not be too large; otherwise, the particle size affects a forming effect of the cold briquette. Setting the particle size to satisfy that the fraction of particles smaller than 1 mm is not less than 90% helps ensure maintenance of a shape of the cold briquette. The chloride content in the iron-containing dust should not be too high; otherwise, the chloride content increases harmful element content of the cold briquette and affects blast furnace operation. Setting the chloride content to be <0.75 wt. % helps avoid erosion of blast furnace lining refractory materials by chloride salts, and helps avoid bonding of a furnace burden or a decrease in permeability caused by the chloride salts.

The binder is an additive for bonding raw material particles to each other. The binder is able to enhance the structural strength of the wet briquette. A type and a proportion of the binder may be determined based on actual needs.

In some embodiments, the binder includes an organic binder and an inorganic binder.

In some embodiments, the binder consists of the organic binder and the inorganic binder in a mass percentage of (10-20%):(80-90%); and/or, the mass of the binder accounts for 2.5-5% of the total mass of the sinter return ore, the undersize material from the blast furnace lump ore, the fine-sized metallized material, and the iron-containing dust.

In some embodiments, the mass percentage of the organic binder to the inorganic binder in the binder may be one of 10%:90%, 12%:88%, 14%:86%, 16%:84%, 18%:82%, or 20%:80%.

In some embodiments, in the binder, the mass percentage of the organic binder to the inorganic binder is according to a mass percentage in a range of (10-18%):(82-90%), (12-20%):(80-88%), (14-20%):(80-86%), (16-18%):(82-84%), (18-20%):(80-82%), (10-14%):(86-90%), (12-16%):(84-88%), (14-18%):(82-86%), or (16-20%):(80-84%).

In some embodiments, the proportion of the mass of the binder to the total mass of the sinter return ore and the undersize material from the blast furnace lump ore, the fine-sized metallized material, and the iron-containing dust may be one of 2.5%, 3%, 3.5%, 4%, 4.5%, or 5%. In some embodiments, the proportion of the mass of the binder to the total mass of the sinter return ore and the undersize material from the blast furnace lump ore, the fine-sized metallized material, and the iron-containing dust may be in a range of 2.5-3%, 2.5-3.5%, 2.5-4%, 2.5-5%, 3-4%, 3-4.5%, 3.5-5%, 4-5%, or 3-5%.

In some embodiments, types and proportions of the organic binder and the inorganic binder may be determined based on actual needs. The organic binder and the inorganic binder may be a single-component binder or a multi-component binder.

In some embodiments, the organic binder includes polyethylene glycol, polyvinylpyrrolidone, polyacrylamide, gelatin, sodium alginate, etc. The inorganic binder includes aluminum dihydrogen phosphate, calcium aluminate, aluminum silicate sol, etc.

In some embodiments, an excessively high dosage of the binder increases cost, while an excessively low dosage of the binder affects strength of the wet briquette. The organic binder and the inorganic binder in the binder is set to be in a mass percentage ratio of 10-20%:80-90%; and/or, the mass of the binder is set to account for 2.5-5% of the total mass of the sinter return ore, the undersize material from the blast furnace lump ore, the fine-sized metallized material, and the iron-containing dust, which helps balance the economic cost and bonding performance of the binder.

In some embodiments, the organic binder includes at least one of a gelatinized starch, a humic acid, a sodium carboxymethyl cellulose, a polyvinyl alcohol, a polyacrylate, or a phenolic resin; and/or, the inorganic binder includes at least one of a bentonite, a sodium silicate, a sodium water glass, or a silica sol.

In some embodiments, the degree of polymerization of organic binders such as the gelatinized starch, the humic acid, the sodium carboxymethyl cellulose, the polyvinyl alcohol, the polyacrylate, and the phenolic resin may be determined based on actual needs. A concentration of solution-form binders, such as the sodium water glass or the silica sol, may be determined based on actual needs.

A modulus of the sodium water glass refers to a molar ratio of SiO₂ to Na₂O in the sodium water glass. When the modulus is higher, the solubility of water glass decreases, the viscosity increases, and the strength after hardening becomes greater. Conversely, when the modulus is lower, the solubility increases, the viscosity decreases, and the strength after hardening is reduced.

In some embodiments, when the inorganic binder includes the sodium water glass, the modulus of the sodium water glass may be determined based on actual needs.

In some embodiments, the modulus of the sodium water glass is in a range of 1.5-3.5.

In some embodiments, the modulus of the sodium water glass may be one of 1.5, 2.0, 2.5, 3.0, 3.3, or 3.5.

In some embodiments, the modulus of the sodium water glass may be in a range of 1.5 to 2.0, 1.5 to 3.0, 1.5 to 3.5, 2.0 to 2.5, 2.0 to 3.3, 2.0 to 3.5, 2.5 to 3.0, 2.5 to 3.3, or 3.0 to 3.5.

In some embodiments, when the inorganic binder includes the silica sol, a content of SiO₂ in the silica sol may be determined based on actual needs.

In some embodiments, the content of SiO₂ in the silica sol is in a range of 20-40 wt. %.

In some embodiments, the content of SiO₂ in the silica sol is in a range of 20-25 wt. %, 20-30 wt. %, 20-35 wt. %, 20-40 wt. %, 25-30 wt. %, 25-35 wt. %, 25-40 wt. %, or 30-40 wt. %.

In some embodiments, an addition amount and composite components of the binder are optimized based on comprehensive considerations of cost, binding effect, impurity content, and other aspects. The organic binder can provide excellent green pellet strength and low-temperature strength for the cold briquette, while the inorganic binder can provide high-temperature strength for the same. The organic binder has low impurity content and good low-temperature binding effect, but high price and poor high-temperature resistance, whereas the inorganic binder has low price and good high-temperature strength, but high impurity content. Therefore, the binder of the present disclosure is formed by combining the organic binder and the inorganic binder according to an appropriate ratio to achieve an optimal comprehensive effect.

In some embodiments, the raw materials of the wet briquette are mixed by an intensive mixer, a horizontal mixer, or a pan grinder.

The intensive mixer is a device for mixing materials through high-speed rotation. The intensive mixer is provided with a plurality of sets of high-speed rotating stirring blades. Rotation directions of adjacent stirring blades are opposite. Through shear force and convective vortex action, the intensive mixer quickly mixes the raw materials of the wet briquette.

The horizontal mixer is a device for mixing materials through stirring. The horizontal mixer adopts a horizontal cylinder structure. Two sets of spiral ribbons are arranged inside the cylinder. Rotation directions of the two sets of spiral ribbons are opposite. Through rotation of the spiral ribbons, the horizontal mixer mixes the raw materials of the wet briquette.

The pan grinder is a device for mixing materials through grinding. The pan grinder includes a grinding wheel and a grinding pan. Through repeated rolling of the grinding wheel, the pan grinder crushes coarse particles in the raw materials and mixes the raw materials of the wet briquette.

In some embodiments, the raw materials of the wet briquette may also be mixed by any feasible mixing device such as a vacuum mixer or a planetary mixer.

The high-pressure double-roller forming is a process of forming the wet briquette of a specific shape, by extruding the mixed raw materials through double rollers. The term “high-pressure” refers to the extrusion force of the double rollers that is able to reach a tonnage level.

The wet briquette is a block-shaped intermediate obtained after forming the raw materials. After subsequent steps such as drying, the wet briquette becomes the cold briquette that serves as the blast furnace burden.

In some embodiments, the mixed raw materials may be subjected to high-pressure double-roller forming by a high-pressure double-roller machine to prepare the wet briquette. The double rollers of the high-pressure double-roller machine may be flat. After the raw materials are extruded and formed into a whole block, the block is divided and granulated to obtain wet briquettes. The surfaces of the double rollers may also be provided with pits matching the shape and size of the target wet briquette. During extrusion forming, the pits on the surfaces of the double rollers guide the raw materials to be directionally embedded and molded, thereby producing wet briquettes with specific shapes and sizes in one step.

In some embodiments, mixing by the intensive mixer, the horizontal mixer, or the pan grinder not only improves mixing uniformity and avoids agglomeration and layering of the raw materials, but also eliminates human errors or operational fluctuations during mixing of raw materials from different batches, ensuring batch stability of the cold briquette.

In some embodiments, shapes and sizes of wet briquettes may be determined based on actual needs. For example, the wet briquettes may have an oblate-spheroid shape, a spherical shape, a strip shape, a block shape, or an irregular shape. For different types of blast furnaces, different shapes and sizes of the wet briquettes may be flexibly selected.

In some embodiments, a forming line pressure of the high-pressure double-roller forming is in a range of 0.6-1.4 t/mm; and/or, a moisture content of the wet briquette is in a range of 4.5-8 wt. %, a shape of the wet briquette is an oblate-spheroid shape, and dimensions of the wet briquette are: a major axis×a minor axis×a height=(15-35 mm)×(13-25 mm)×(10-18 mm).

The forming line pressure is a pressure applied by the double rollers per unit length on the raw materials, during operation of the high-pressure double-roller machine.

In some embodiments, the forming line pressure of the high-pressure double-roller forming may be one of 0.6 t/mm, 0.7 t/mm, 0.8 t/mm, 0.9 t/mm, 1.0 t/mm, 1.1 t/mm, 1.2 t/mm, 1.3 t/mm, or 1.4 t/mm; the moisture content of the wet briquette may be one of 4.5 wt. %, 5.0 wt. %, 5.5 wt. %, 6.0 wt. %, 6.5 wt. %, 7.0 wt. %, 7.5 wt. %, or 8.0 wt. %.

In some embodiments, the forming line pressure of the high-pressure double-roller forming may be in a range of 0.6-0.8 t/mm, 0.6-0.9 t/mm, 0.7-0.9 t/mm, 0.7-1.0 t/mm, 0.8-1.0 t/mm, 0.8-1.1 t/mm, 0.9-1.1 t/mm, 0.9-1.2 t/mm, 1.0-1.3 t/mm, 1.1-1.3 t/mm, or 1.1-1.4 t/mm; the moisture content of the wet briquette may be in a range of 4.5-6.5 wt. %, 4.5-6.0 wt. %, 5.0-6.5 wt. %, 5.5-6.5 wt. %, 5.5-7.0 wt. %, 6.0-7.0 wt. %, 6.0-7.5 wt. %, 6.5-7.5 wt. %, 6.5-8.0 wt. %, or 4.5-7.0 wt. %.

In some embodiments, the major axis size of the wet briquette may be one of 15 mm, 18 mm, 22 mm, 25 mm, 30 mm, or 35 mm; the minor axis size of the wet briquette may be one of 13 mm, 14 mm, 17 mm, 20 mm, 22 mm, or 25 mm; the height of the wet briquette may be one of 10 mm, 12 mm, 14 mm, 16 mm, or 18 mm.

In some embodiments, the major axis size of the wet briquette may be in a range of 15-22 mm, 15-25 mm, 18-30 mm, 22-30 mm, 25-30 mm, 15-30 mm, or 18-35 mm; the minor axis size of the wet briquette may be in a range of 13-17 mm, 13-20 mm, 14-17 mm, 14-22 mm, 17-20 mm, 17-25 mm, 20-25 mm, 13-22 mm, or 14-25 mm; the height of the wet briquette may be in a range of 10-14 mm, 12-16 mm, 14-18 mm, 10-16 mm, or 12-18 mm.

In some embodiments, the forming line pressure should not be too large or too small. When the forming line pressure is too small, the forming pressure is insufficient, and the cold briquette has low strength. When the forming line pressure is too large, it not only destroys the original particle size composition of the material, reducing the strength of the cold briquette, but also increases equipment energy consumption and reduces service life. The forming line pressure of the high-pressure double-roller forming is set in a range of 0.6-1.4 t/mm, to ensure that the cold briquette has appropriate mechanical strength.

In some embodiments, the moisture content in the wet briquette needs to be controlled within an appropriate range. A moisture content that is too high or too low is not conducive to cold pressing and forming of the briquette. When the moisture content is too low, the binder is difficult to fully dissolve and function. When the moisture content is too high, the binder is lost with water during the pressing process. Both situations affect the forming effect and the strength of the cold briquette. The moisture content of the wet briquette is set to be in a range of 4.5-8 wt. %, which helps the forming effect of the cold briquette. The shape of the cold briquette is set to be an oblate-spheroid shape: the curved surface structure of the oblate-spheroid shape can repeatedly disperse impact forces, thereby enhancing the compressive strength of the cold briquette. The dimension of the cold briquette should not be too large or too small. When the size is too large, reducibility of the cold briquette is poor. When the size is too small, porosity of the blast furnace burden is reduced, affecting permeability. Dimensions of the wet briquette are set to be: a major axis×a minor axis×a height=(15-35 mm)×(13-25 mm)×(10-18 mm), ensuring that the cold briquette has an appropriate size, neither causing uneven sintering due to excessive size nor causing insufficient structural strength of the cold briquette due to insufficient size.

To ensure the dimensional uniformity of wet briquette, during the high-pressure double-roller forming process of the present disclosure, the resulting formed material may be subjected to screening. The undersize material of excessively small dimensions is returned for reforming through the high-pressure double-roller forming. The oversize material constitutes wet briquettes that meet the specified dimensional requirements.

The low-temperature drying and consolidation is a process of drying and consolidating the wet briquette. Because the wet briquette has a high moisture content and low mechanical strength, the wet briquette first needs to be dried to ensure that the moisture content of the wet briquette is reduced to 4.5-8 wt. %. Subsequently, the wet briquette is heated and consolidated, to ensure that the cold briquette has appropriate compressive strength. The term “low-temperature” refers to a drying temperature and a consolidation temperature of the present disclosure, being lower than drying temperatures and consolidation temperatures of traditional manners, resulting in lower energy consumption and being more environmentally friendly.

In some embodiments, low-temperature drying and consolidation may be performed in various ways. The drying process and the consolidation process may adopt the same or different manners. For example, when drying the wet briquette, manners such as infrared radiation heating, vacuum freeze-drying, microwave heating, or natural air drying may be adopted. When consolidating the wet briquette, manners such as infrared radiation heating, microwave heating, plasma sintering, or electric heating may be adopted. Parameters such as the drying temperature, the drying time, the consolidation temperature, and the consolidation time may be determined based on actual needs.

In some embodiments, hot air is used during both the drying step and the consolidation step of the low-temperature drying and consolidation, the drying temperature is in a range of 100-180 °C, and the drying time is in a range of 13-22 min; the consolidation temperature is in a range of 180-280 °C, and the consolidation time is in a range of 11-19 min.

In some embodiments, the drying temperature may be one of 100 °C, 120 °C, 135 °C, 150 °C, 165 °C, or 180 °C; the drying time may be one of 13 min, 15 min, 16 min, 18 min, 20 min, or 22 min; the consolidation temperature may be one of 180 °C, 200 °C, 220 °C, 240 °C, 260 °C, or 280 °C; the consolidation time may be one of 11 min, 12 min, 13 min, 15 min, 17 min, or 19 min.

In some embodiments, the drying temperature may be in a range of 100-135 °C, 120-150 °C, 135-165 °C, 150-180 °C, 100-150 °C, 120-165 °C, 135-180 °C, 100-165 °C, or 120-180 °C; the drying time may be in a range of 13-15 min, 15-18 min, 16-20 min, 18-22 min, 13-16 min, 15-20 min, 16-22 min, 13-18 min, or 15-22 min; the consolidation temperature may be in a range of 180-200 °C, 200-220 °C, 220-240 °C, 240-260 °C, 260-280 °C, 180-220 °C, 200-240 °C, 220-260 °C, or 240-280 °C; the consolidation time may be in a range of 11-13 min, 12-15 min, 13-17 min, 15-19 min, 11-15 min, 12-17 min, 13-19 min, 11-17 min, or 12-19 min.

In some embodiments, hot air is used throughout the low-temperature drying and consolidation process, the drying temperature is in a range of 100-180 °C, and the drying time is in a range of 13-22 min; the consolidation temperature is in a range of 180-280 °C, and the consolidation time is in a range of 11-19 min. The heating temperatures of the present disclosure are significantly lower than heating temperatures of a secondary sintering process, eliminating the need to consume a large amount of fossil fuels and effectively reducing energy consumption and carbon emissions. Selecting the hot air drying and consolidation manner allows high-temperature waste gas generated during blast furnace ironmaking to be used as a heat source, achieving a plurality of uses of heat energy and helping to reduce production costs.

In some embodiments, the cold briquette has a compressive strength≥2300 N/P, a tumble index (+6.3 mm)≥80%, an abrasion index≤8%, a low-temperature reduction disintegration index (+3.15 mm)≥70%, and a reducibility≥75%. The compressive strength of cold briquette not less than 2300 N/P means that each cold briquette is able to withstand a pressure of at least 2300 N without breaking.

The tumble index (+6.3 mm) is used to measure wear resistance and impact resistance of the cold briquette. The cold briquette is placed into a tumble drum for a plurality of rotations. After removal, the cold briquette is screened with a sieve having an aperture of 6.3 mm. The oversize material with a particle size≥6.3 mm is weighed. A mass ratio of the oversize material is the tumble index. A higher tumble index indicates stronger anti-breakage performance of the cold briquette.

The abrasion index is used to measure the wear resistance of the cold briquette, expressed as a mass proportion of undersize material generated by abrasion. A lower abrasion index indicates stronger wear resistance of the cold briquette.

The low-temperature reduction disintegration index (+3.15 mm) is used to measure a feature of the cold briquette resisting fragmentation and pulverization caused by low-temperature reduction reactions. When the cold briquette is at a low reduction temperature in a range of 400-600 °C, iron oxides are converted into metallic iron. The reduction causes lattice distortion, leading to fragmentation and pulverization of the cold briquette under internal stress. After reduction, the cold briquette is removed and screened with a sieve having an aperture of 3.15 mm. The oversize material with a particle size≥3.15 mm is weighed. A mass ratio of the oversize material is the low-temperature reduction disintegration index (+3.15 mm).

The reducibility is used to measure an ease with which iron oxides in the cold briquette are reduced to metallic iron. After reduction, the proportion of metallic iron (MFe) to total iron (TFe) in the cold briquette is the reducibility. A higher reducibility indicates that the iron oxides in the cold briquette are more easily reduced to the metallic iron, and the consumption of reducing agents such as the coke in a blast furnace can be reduced.

In some embodiments, the compressive strength of the cold briquette may be one of ≥2300 N/P, ≥2500 N/P, ≥2700 N/P, ≥3000 N/P, ≥3200 N/P, or ≥3500 N/P.

In some embodiments, the tumble index (+6.3 mm) may be one of 80%, 85%, 90%, 95%, or 100%; the abrasion index may be one of 0%, 1%, 2%, 3%, 4%, 5%, 6%, 7%, or 8%; the low-temperature reduction disintegration index (+3.15 mm) may be one of 70%, 75%, 80%, 85%, 90%, 95%, or 100%; the reducibility may be one of 75%, 80%, 85%, 90%, 95%, or 100%.

In some embodiments, the tumble index (+6.3 mm) may be in a range of 80%-95%, 85%-100%, 80%-90%, 85%-95%, or 90%-100%; the abrasion index may be in a range of 0%-5%, 1%-7%, 2%-8%, 0%-3%, 1%-4%, 2%-5%, 3%-6%, 4%-7%, or 5%-8%; the low-temperature reduction disintegration index (+3.15 mm) may be in a range of 70%-80%, 75%-85%, 80%-100%, 90%-100%, 70%-85%, 75%-90%, 80%-95%, 85%-100%, 70%-90%, or 75%-95%; the reducibility may be in a range of 75%-95%, 80%-100%, 75%-85%, 80%-90%, 85%-95%, or 75%-100%.

In some embodiments, the compressive strength of the cold briquette is set to be ≥2300 N/P, the tumble index (+6.3 mm) of the cold briquette is set to be ≥80%, the abrasion index of the cold briquette is set to be ≤8%, and the low-temperature reduction disintegration index (+3.15 mm) of the cold briquette is set to be ≥70%, ensuring that the cold briquette has sufficient structural strength, is not prone to breakage during loading, unloading, transportation, and bearing burden pressure in the blast furnace, reducing the generation of dust in the blast furnace, avoiding pore blockage, and maintaining permeability of the blast furnace burden; the reducibility of the cold briquette is set to be ≥75%, ensuring reduction efficiency of iron oxides in the blast furnace, reducing consumption of fossil fuels, and reducing coke ratio and carbon emissions.

A key point of the technical solution of the present disclosure lies in adding a small count of raw materials such as the undersize material from blast furnace lump ore, the combustible organic waste powder, the fine-sized metallized material, and the iron-containing dust to the sinter return ore for the component regulation, and performing the cold briquetting and the rapid consolidation under the action of the binder, to prepare the iron-containing burden meeting the blast furnace requirements in a low-carbon and efficient manner. A reason why the sinter return ore can be prepared into an iron-containing burden meeting blast furnace requirements in the present disclosure further lies in utilizing efficient coupling effects among multiple components in a raw material system, which can improve strength of the cold briquette, reduce the carbon emissions, and improve metallurgical performance of the cold briquette.

Regarding improvement of strength of the cold briquette: in one respect, the introduced combustible organic waste powder can be uniformly distributed on surfaces of sinter return ore particles during a mixing process to form an interface transition layer; meanwhile, the combustible organic waste powder has excellent compressibility, and the combustible organic waste powder effectively fills gaps between coarse sinter return ore particles through plastic deformation during a forming stage, which can improve packing density of raw materials and reduce stress concentration caused by excessive porosity during a pressing process; moreover, organic components in the combustible organic waste powder form chemical bonds with the binder, further strengthening interface bonding strength and enhancing briquette strength. In another respect, a coupling effect exists between the introduced fine-sized metallized material and the iron-containing dust; the fine-sized metallized material has a high metallic iron content, and chloride in the iron-containing dust can serve as a rusting agent to accelerate a rusting reaction on surfaces of the metallic iron, thereby improving strength of the cold briquette through rusting consolidation; moreover, the fine-sized metallized material has good plasticity, and the fine-sized metallized material achieves densified filling through particle extension deformation during a cold briquetting process, which can significantly improve strength of the cold briquette.

Regarding low carbon emissions: combustible organic waste resources can be effectively utilized to reduce total energy consumption of steel production; moreover, adding the combustible organic waste powder to raw materials of the cold briquette not only utilizes a feature that the combustible organic waste powder contains more organic matter to provide heat through combustion during a blast furnace reduction process, thereby reducing consumption of fossil energy, but also the combustible organic waste powder decomposes at high temperature during the blast furnace reduction process, to generate a large count of organic small-molecule gases (CO, H₂, CH₄, etc.), which can serve as reducing agents to participate in reduction of iron oxides, further reducing the blast furnace coke ratio.

Regarding improvement of metallurgical performance of the cold briquette: utilizing a microporous structure, formed by decomposition of the combustible organic waste powder at high temperature, is conducive to diffusion of reducing gases, which can improve metallurgical performance of the cold briquette, thereby synergistically utilizing solid waste resources such as sinter return ore, fine-sized metallized material, and iron-containing dust, and improving energy utilization efficiency. The metallic iron in the fine-sized metallized material can effectively improve overall reducibility of the cold briquette; moreover, during a reduction process, the metallic iron serves as a “skeleton phase” to absorb expansion stress through elastic deformation, which can inhibit crack initiation and propagation, thereby improving the problem of increased powdering rate, caused by volume expansion during the reduction process.

In summary, the technical solution of the present disclosure does not require returning the sinter return ore and the undersize material from the blast furnace lump ore to a sintering process for repeated sintering, thereby avoiding energy waste and reducing carbon emissions; meanwhile, the technical solution can also utilize solid waste resources such as combustible organic waste powder, fine-sized metallized material, and iron-containing dust, reduce solid waste accumulation, and further reduce energy consumption of a steel production process.

Proportions of various raw materials of the cold briquette of the present disclosure are optimized; compared with the sinter return ore, proportions of the undersize material from blast furnace lump ore, the fine-sized metallized material, and the iron-containing dust should not be too high; for example, the undersize material from blast furnace lump ore has high hardness, and an excessively high proportion affects the forming effect; when the proportion of the fine-sized metallized material is too low, the plastic buffering and filling effect is limited; and when the proportion of the fine-sized metallized material is too high, the cold briquette softens prematurely during the blast furnace reduction process, which affects permeability; when the proportion of the iron-containing dust is too low, the chloride content in the dust is insufficient, so the strength obtained by the briquette through rusting consolidation is limited; when the proportion too high, the amount of chloride introduced is excessive, which disrupts the normal production of the blast furnace. The proportion of the combustible organic waste powder should not be too high; otherwise, during a reduction process of the cold briquette, the combustible organic waste burns and decomposes, significantly increasing the porosity of the cold briquette and affecting the strength of the cold briquette.

The method for low-carbon preparation of the blast furnace burden from the sinter return ore provided by the present disclosure includes the following steps:
(1) Mixing the combination of the sinter return ore, the undersize material from the blast furnace lump ore, the combustible organic waste powder, the fine-sized metallized material, and the iron-containing dust to form a first mixture; wherein the combined mass of the sinter return ore and the undersize material from blast furnace lump ore accounts for 92.5-93.5 wt. %, the combustible organic waste powder accounts for 5-6 wt. %, the fine-sized metallized material accounts for 1-2 wt. %, and the iron-containing dust accounts for 0.5-1.5 wt. % of the total mass of the components in the first mixture; wherein the fine-sized metallized material and the undersize material from the blast furnace lump ore each satisfy that the fraction of particles smaller than 5 mm is not less than 90 wt. %; wherein the fine-sized metallized material satisfies that the MFe content is not less than 50 wt. %; wherein the combustible organic waste powder satisfies that the fraction of particles smaller than 1 mm is not less than 93 wt. % and the calorific value is not less than 10 MJ/kg; wherein the iron-containing dust satisfies that the fraction of particles smaller than 1 mm is not less than 90 wt. % and the chloride content is less than 0.75 wt. %; wherein the combustible organic waste powder includes at least one of the waste biomass, the waste rubber, or the waste plastic; wherein the fine-sized metallized material includes at least one of the undersize material from the gas-based shaft furnace reduction product, the undersize material from the rotary hearth furnace reduction product, the undersize material from the coal-based rotary kiln reduction product, or the undersize material from the coal-based shaft furnace reduction product.
(2) Fully mixing the first mixture, the composite binder, and the water in a certain proportion to obtain the second mixture; wherein the addition amount of the composite binder accounts for 2.5-5 wt. % of the total mass of the sinter return ore, the undersize material from the blast furnace lump ore, the fine-sized metallized material, and the iron-containing dust; wherein the moisture content of the second mixture is in a range of 4.5-8 wt. %; wherein the composite binder includes the organic binder and the inorganic binder in a mass percentage of (10-20%):(80-90%); wherein the organic binder includes at least one of gelatinized starch, humic acid, sodium carboxymethyl cellulose, polyvinyl alcohol, polyacrylate, or phenolic resin; wherein the inorganic binder includes at least one of bentonite, sodium silicate, sodium water glass, or silica sol; wherein the mixing is performed by the intensive mixer, the horizontal mixer, or the pan grinder;
(3) Performing double-roller forming on the second mixture using the high-pressure double-roller briquetting machine (also referred to as the high-pressure double-roller machine), screening the formed material, returning the undersize material to step (2) for re-forming, and collecting the oversize material as the wet briquette; wherein the forming line pressure of the double-roller forming is in a range of 0.6-1.4 t/mm; wherein the wet briquette has the oblate-spheroid shape, and dimensions of the wet briquette are: the major axis×the minor axis×the height=(15-35 mm)×(13-25 mm)×(10-18 mm).
(4) Subjecting the wet briquette to the low-temperature drying and consolidation using the hot air, to obtain the cold briquette. The drying temperature is in a range of 100-180 °C, and the drying time is in a range of 13-22 min; the consolidation temperature is in a range of 180-280 °C, and the consolidation time is in a range of 11-19 min. The cold briquette has the compressive strength≥2300 N/P, the tumble index (+6.3 mm)≥80%, the abrasion index≤8%, the low-temperature reduction disintegration index (+3.15 mm)≥70%, and the reducibility≥75%.

Compared with the prior art, beneficial effects brought by the technical solution of the present disclosure include:
(1) The present disclosure utilizes raw materials such as undersize material from blast furnace lump ore, combustible organic waste powder, fine-sized metallized material, and iron-containing dust, to combine with sinter return ore to prepare the cold briquette; a key point lies in utilizing efficient coupling effects among multiple components in a raw material system, which can improve strength of the cold briquette, reduce carbon emissions, and improve metallurgical performance of the cold briquette, thereby preparing an iron-containing burden meeting blast furnace requirements in a low-carbon and efficient manner. In one respect, the combustible organic waste powder has a fine particle size, and the combustible organic waste powder can be uniformly distributed on surfaces of sinter return ore particles during a mixing process to form an interface transition layer; meanwhile, the combustible organic waste powder has excellent compressibility, and the combustible organic waste powder effectively fills gaps between coarse sinter return ore particles through plastic deformation during a forming stage, which can improve packing density of raw materials, and reduce stress concentration caused by excessive porosity during a pressing process; moreover, organic components in the combustible organic waste powder form chemical bonds with the binder, further strengthening interface bonding strength and enhancing the strength of the briquette. In another respect, a coupling effect exists between the fine-sized metallized material and the iron-containing dust; the fine-sized metallized material has a high metallic iron content, and the chloride in the iron-containing dust can serve as the rusting agent, to accelerate the rusting reaction on the surfaces of the metallic iron, thereby improving the strength of the cold briquette through rusting consolidation. In addition, the fine-sized metallized material has good plasticity, and the fine-sized metallized material achieves densified filling, through particle extension deformation during a cold briquetting process, which can significantly improve strength of the cold briquette.
(2) The preparation process of the cold briquette of the present disclosure can effectively utilize combustible organic waste resources and reduce total energy consumption of steel production. Adding the combustible organic waste powder to raw materials of the cold briquette, in one respect, the combustible organic waste powder contains more organic matter, and the combustible organic waste powder can provide heat through combustion during a blast furnace reduction process, thereby reducing consumption of fossil energy. In another respect, these substances decompose at high temperature during the blast furnace reduction process, to generate a large amount of organic small-molecule gases (CO, H₂, CH₄, etc.), which can serve as the reducing agents to participate in reduction of iron oxides, further reducing the blast furnace coke ratio. In addition, the microporous structure formed by decomposition of the combustible organic waste powder at high temperature is conducive to diffusion of the reducing gases, which can improve the metallurgical performance of the cold briquette.
(3) The preparation process of the cold briquette of the present disclosure can synergistically utilize solid waste resources such as the sinter return ore, the fine-sized metallized material, and the iron-containing dust, and improve energy utilization efficiency. In one respect, both the fine-sized metallized material and the iron-containing dust contain a certain amount of iron-containing substances, which can be fully utilized to reduce solid waste accumulation. In another respect, the metallic iron in the fine-sized metallized material can effectively improve the overall reducibility of the cold briquette; moreover, during the reduction process, the metallic iron serves as the skeleton phase, to absorb the expansion stress through the elastic deformation, which can inhibit the crack initiation and propagation, thereby improving a problem of the increased powdering rate caused by the volume expansion during the reduction process.

The following takes preparation of a cold briquette as an example, to further illustrate the method for low-carbon preparation of the blast furnace burden from the sinter return ore provided by some embodiments of the present disclosure.

Standards related to performance testing of the cold briquette in the following embodiments are: a test standard for compressive strength is GB/T 14201-2018, ISO 4700:2015; test standards for tumble index and abrasion index are GB/T 24531-2009, ISO 3271:2007; a test standard for low-temperature reduction disintegration index is GB/T 31923-2015.

### Example 1

The sinter return ore, the undersize material from the blast furnace lump ore, the combustible organic waste powder, the fine-sized metallized material, and the iron-containing dust were preliminarily mixed according to 92.5 wt. %:5 wt. %:1 wt. %:1.5 wt. % to obtain the first mixture; wherein the fraction of particles smaller than 5 mm of the fine-sized metallized material and the undersize material from the blast furnace lump ore was 90 wt. %, and the MFe content of the fine-sized metallized material was 55 wt. %; the fraction of particles smaller than 1 mm of the combustible organic waste powder was 93 wt. %, and the calorific value of the combustible organic waste powder was 10 MJ/kg; the fraction of particles smaller than 1 mm of the iron-containing dust was 90 wt. %, and the chloride content of the iron-containing dust was 0.70 wt. %; the combustible organic waste powder was the waste biomass, specifically the sawdust; the fine-sized metallized material was the undersize material from the rotary hearth furnace reduction product; the iron-containing dust was the mixture consisting of 70 wt. % of the sinter dedusting ash and 30 wt. % of the blast furnace secondary dedusting ash. The first mixture, the composite binder, and the water were then fully mixed according to a certain proportion to obtain the second mixture; wherein the addition amount of the composite binder accounted for 3.5 wt. % of the first mixture; the moisture content of the second mixture was 5.0 wt. %; wherein the composite binder consisted of 20 wt. % of the organic binder and 80 wt. % of the inorganic binder; the organic binder was the sodium carboxymethyl cellulose; the inorganic binder was the sodium silicate; the mixing device was the intensive mixer. The high-pressure double-roller briquetting machine was used to perform double-roller forming on the second mixture, the formed material was screened, and the oversize material was the wet briquette; wherein the forming line pressure was 1.1 t/mm; the wet briquette had the oblate-spheroid shape, and the dimensions of the wet briquette were 35 mm×25 mm×18 mm. The hot air was used to perform low-temperature drying and consolidation on the wet briquette to obtain the cold briquette. The drying temperature was 180 °C, and the drying time was 16 min; the consolidation temperature was 280 °C, and the consolidation time was 12 min.

The compressive strength of the cold briquette prepared in Example 1 is 2330 N/P, the tumble index (+6.3 mm) of the cold briquette is 82%, the abrasion index of the cold briquette is 7%, the low-temperature reduction disintegration index (+3.15 mm) of the cold briquette is 74%, and the reducibility of the cold briquette is 79%.

### Comparative Example 1

Operations of Comparative example 1 are similar to the operations of Example 1. The only difference resides in that Comparative example 1 does not add the combustible organic waste powder. Other conditions are found in Example 1.

A compressive strength of the cold briquette prepared in Comparative example 1 is 2051 N/P, a tumble index (+6.3 mm) of the cold briquette is 77%, an abrasion index of the cold briquette is 11.5%, a low-temperature reduction disintegration index (+3.15 mm) of the cold briquette is 64%, and a reducibility of the cold briquette is 74.3%.

It shows that, from Example 1 and Comparative example 1, after adding the combustible organic waste powder, organic components in the powder forms chemical bonds with the binder, further strengthening interface bonding strength, which could enhance structural strength of the cold briquette, improve compressive strength and tumble index of the cold briquette, and reduce the abrasion index; the microporous structure formed by decomposition of the combustible organic waste powder at high temperature is conducive to diffusion of reducing gases inside the cold briquette, alleviating fragmentation and powdering under action of internal stress, and improving the low-temperature reduction disintegration index; organic matter in the combustible organic waste powder could provide heat through combustion, reducing consumption of fossil energy, and the organic waste decompose at the high temperature to generate small-molecule reducing agents such as CO and H₂, which participate in reduction reactions of iron oxides, further improving the reducibility.

### Example 2

The sinter return ore, the undersize material from the blast furnace lump ore, the combustible organic waste powder, the fine-sized metallized material, and the iron-containing dust were preliminarily mixed according to 92.5 wt. %:5 wt. %:2 wt. %:0.5 wt. % to obtain the first mixture; wherein the fraction of particles smaller than 5 mm of the fine-sized metallized material and the undersize material from the blast furnace lump ore was 94 wt. %, and the MFe content of the fine-sized metallized material was 67 wt. %; the fraction of particles smaller than 1 mm of the combustible organic waste powder was 96 wt. %, and the calorific value of the combustible organic waste powder was 17 MJ/kg; the fraction of particles smaller than 1 mm of the iron-containing dust was 94 wt. %, and the chloride content of the iron-containing dust was 0.50 wt. %; the combustible organic waste powder was the waste plastic, specifically the waste PE packaging film; the fine-sized metallized material was the mixture of 25 wt. % of the undersize material from the gas-based shaft furnace reduction product and 75 wt. % of the undersize material from the rotary hearth furnace reduction product; the iron-containing dust was the converter dust-and-sludge. The first mixture, the composite binder, and the water were then fully mixed according to a certain proportion to obtain the second mixture; wherein the addition amount of the composite binder accounted for 5 wt. % of the first mixture; the moisture content of the second mixture was 6.5 wt. %; wherein the composite binder consisted of 10 wt. % of the organic binder and 90 wt. % of the inorganic binder; the organic binder was the mixture of 50 wt. % of sodium carboxymethyl cellulose and 50 wt. % of phenolic resin; the inorganic binder was the mixture of 20 wt. % of bentonite and 80 wt. % of sodium water glass (modulus 3.3); the mixing device was the pan grinder. The high-pressure double-roller forming machine was used to perform high-pressure double-roller forming on the second mixture. The formed material was screened. The oversize material was the wet briquette. The forming line pressure was 0.9 t/mm. The wet briquette had the oblate-spheroid shape. The size of the wet briquette was 18 mm×14 mm×12 mm. The hot air was used to perform low-temperature drying and consolidation on the wet briquette to obtain the cold briquette. The drying temperature was 150 °C. The drying time was 20 min. The consolidation temperature was 250 °C. The consolidation time was 15 min.

The compressive strength of the cold briquette prepared in Example 2 is 2470 N/P. The tumble index (+6.3 mm) of the cold briquette is 88%. The abrasion index of the cold briquette is 5.4%. The low-temperature reduction disintegration index (+3.15 mm) of the cold briquette is 81%. The reducibility of the cold briquette is 83%.

### Comparative Example 2

Operations of Comparative example 2 are similar to the operations of Example 2. The only difference resides in that Comparative example 2 does not add the fine-sized metallized material. Other conditions are found in Example 2.

A compressive strength of the cold briquette prepared in Comparative example 2 is 2018 N/P. A tumble index (+6.3 mm) of the cold briquette is 74%. An abrasion index of the cold briquette is 12%. A low-temperature reduction disintegration index (+3.15 mm) of the cold briquette is 61.5%. A reducibility of the cold briquette is 73%.

It shows that, from Example 2 and Comparative example 2, after the fine-sized metallized material is added, the fine-sized metallized material fills particle gaps through plastic deformation and undergoes rust consolidation coupled with the iron-containing dust to strengthen the interfacial bonding strength. The fine-sized metallized material can enhance the structural strength of the cold briquette, improve the compressive strength and the tumble index of the cold briquette, and reduce the abrasion index of the cold briquette. The metallic iron in the fine-sized metallized material serves as the skeleton phase to absorb expansion stress during the reduction process through elastic deformation, inhibiting crack initiation and propagation and improving the low-temperature reduction disintegration index. A high content of metallic iron in the fine-sized metallized material can improve the overall reducibility of the cold briquette, further improving the reducibility.

### Example 3

The sinter return ore, the undersize material from the blast furnace lump ore, the combustible organic waste powder, the fine-sized metallized material, and the iron-containing dust were preliminarily mixed according to the ratio of 92.5 wt. %:6 wt. %:1 wt. %:0.5 wt. % to obtain the mixture 1. The fraction of particles smaller than 5 mm of the fine-sized metallized material and the undersize material from the blast furnace lump ore was 96 wt. %. The MFe content in the fine-sized metallized material was 77 wt. %. The fraction of particles smaller than 1 mm of the combustible organic waste powder was 98 wt. %. The calorific value of the combustible organic waste powder was 13 MJ/kg. The fraction of particles smaller than 1 mm of the iron-containing dust was 97 wt. %. The chloride content in the iron-containing dust was 0.66 wt. %. The combustible organic waste powder was the mixture of 50 wt. % of the scrap tire and 50 wt. % of the corn straw. The fine-sized metallized material was the undersize material from the gas-based shaft furnace reduction product. The iron-containing dust was the sinter dedusting ash. The mixture 1, the composite binder, and the water were then thoroughly mixed according to a certain ratio to obtain the mixture 2. The addition amount of the composite binder accounted for 4.5 wt. % of the mixture 1. The moisture content of the mixture 2 was 6 wt. %. The composite binder consisted of 16 wt. % of the organic binder and 84 wt. % of the inorganic binder. The organic binder was the mixture of 20 wt. % of the humic acid, 60 wt. % of the sodium carboxymethyl cellulose, and 20 wt. % of the polyacrylate. The inorganic binder was the mixture of 60 wt. % of the sodium silicate, 20 wt. % of the sodium water glass (modulus 3.3), and 20 wt. % of the silica sol (silicon dioxide content 30 wt. %). The mixing device was the intensive mixer. The high-pressure double-roller forming machine was used to perform high-pressure double-roller forming on the mixture 2. The formed material was screened. The oversize material was the wet briquette. The forming line pressure was 0.8 t/mm. The wet briquette had the oblate-spheroid shape. The size of the wet briquette was 22 mm×17 mm×14 mm. The hot air was used to perform low-temperature drying and consolidation on the wet briquette to obtain the cold briquette. The drying temperature was 100 °C. The drying time was 22 min. The consolidation temperature was 260 °C. The consolidation time was 19 min.

The compressive strength of the cold briquette prepared in Example 3 is 2520 N/P. The tumble index (+6.3 mm) of the cold briquette is 90%. The abrasion index of the cold briquette is 4.7%. The low-temperature reduction disintegration index (+3.15 mm) of the cold briquette is 80%. The reducibility of the cold briquette is 81%.

### Comparative Example 3

Operations of Comparative example 3 are similar to the operations of Example 3. The only difference resides in that Comparative example 3 does not add the iron-containing dust. Other conditions are found in Example 3.

A compressive strength of the cold briquette is 2187 N/P. A tumble index (+6.3 mm) of the cold briquette is 80.4%. An abrasion index of the cold briquette is 11.3%. A low-temperature reduction disintegration index (+3.15 mm) of the cold briquette is 71.5%. A reducibility of the cold briquette is 77%.

It shows that, from Example 3 and Comparative example 3, after the iron-containing dust is added, the chloride in the iron-containing dust serves as the rusting agent to accelerate the rusting reaction on the surface of the fine-sized metallized material. Rust consolidation enhances the inter-particle bonding force and fills gaps to improve compactness. The iron-containing dust can enhance the structural strength of the cold briquette, improve the compressive strength and the tumble index of the cold briquette, and reduce the abrasion index of the cold briquette. The rust consolidation improves the structural stability of the cold briquette, reducing pulverization caused by volume expansion during the reduction process and improving the low-temperature reduction disintegration index. The iron-containing substances in the iron-containing dust participate in the reduction reaction, and the microporous structure formed by the rust consolidation facilitates diffusion of the reducing gas, further improving the reducibility.

What is claimed is:

1. A method for low-carbon preparation of a blast furnace burden from a sinter return ore, including:
mixing the sinter return ore with an undersize material from a blast furnace lump ore, a combustible organic waste powder, a fine-sized metallized material, an iron-containing dust, a binder, and water, forming a wet briquette by high-pressure double-roller forming, and subjecting the wet briquette to low-temperature drying and consolidation to obtain a cold briquette;
wherein, in a mass percentage, a combined mass of the sinter return ore and the undersize material from the blast furnace lump ore accounts for 92.5-93.5%, the combustible organic waste powder accounts for 5-6%, the fine-sized metallized material accounts for 1-2%, and the iron-containing dust accounts for 0.5-1.5%;
wherein the fine-sized metallized material includes an undersize material from metallized pellets obtained from a direct reduction process or an indirect reduction process.

2. The method according to claim 1, wherein:
the combustible organic waste powder includes at least one of a waste biomass, a waste rubber, or a waste plastic.

3. The method according to claim 2, wherein:
the waste biomass includes at least one of a sawdust, a bark, a rice husk, or a corn straw;
the waste rubber includes at least one of a scrap tire, a rubber sealing strip, a rubber hose, an industrial rubber product waste, or a rubber processing scrap;
the waste plastic includes at least one of a polyethylene packaging film, a polypropylene container, a polyvinyl chloride pipe, a polyester bottle, a polystyrene foam, or an agricultural film.

4. The method according to claim 1, wherein:
a particle size of the fine-sized metallized material satisfies that a fraction of particles smaller than 5 mm is not less than 90 wt. %;
a particle size of the undersize material from the blast furnace lump ore satisfies that a fraction of particles smaller than 5 mm is not less than 90 wt. %;
an MFe content in the fine-sized metallized material is not less than 50 wt. %;
a particle size of the combustible organic waste powder satisfies that a fraction of particles smaller than 1 mm is not less than 93 wt. %;
and/or,
a calorific value of the combustible organic waste powder is not less than 10 MJ/kg.

5. The method according to claim 1, wherein:
the binder consists of an organic binder and an inorganic binder in a mass percentage of (10-20%):(80-90%);
and/or,
a mass of the binder accounts for 2.5-5% of a total mass of the sinter return ore, the undersize material from the blast furnace lump ore, the fine-sized metallized material, and the iron-containing dust.

6. The method according to claim 5, wherein:
the organic binder includes at least one of a gelatinized starch, a humic acid, a sodium carboxymethyl cellulose, a polyvinyl alcohol, a polyacrylate, or a phenolic resin;
and/or,
the inorganic binder includes at least one of a bentonite, a sodium silicate, a sodium water glass, or a silica sol.

7. The method according to claim 1, wherein:
the iron-containing dust includes at least one of a sinter dedusting ash, a blast furnace secondary dedusting ash, a converter dust-and-sludge, a casthouse dust, or a cold rolling sludge;
and/or,
a particle size of the iron-containing dust satisfies that a fraction of particles smaller than 1 mm is not less than 90 wt. %, and a chloride content in the iron-containing dust is <0.75 wt. %.

8. The method according to claim 1, wherein:
a forming line pressure of the high-pressure double-roller forming is in a range of 0.6-1.4 t/mm;
and/or,
a moisture content of the wet briquette is in a range of 4.5-8 wt. %, a shape of the wet briquette is an oblate-spheroid shape, and dimensions of the wet briquette are: a major axis×a minor axis×a height=(15-35 mm)×(13-25 mm)×(10-18 mm).

9. The method according to claim 1, wherein:
hot air is used during both a drying step and a consolidation step of the low-temperature drying and consolidation, a drying temperature is in a range of 100-180 °C, and a drying time is in a range of 13-22 min;
a consolidation temperature is in a range of 180-280 °C, and a consolidation time is in a range of 11-19 min.

10. The method according to claim 1, wherein:
the fine-sized metallized material includes at least one of an undersize material from a gas-based shaft furnace reduction product, an undersize material from a rotary hearth furnace reduction product, an undersize material from a coal-based rotary kiln reduction product, or an undersize material from a coal-based shaft furnace reduction product.

11. The method according to claim 1, wherein:
the cold briquette has a compressive strength≥2300 N/P, a tumble index (+6.3 mm)≥80%, an abrasion index≤8%, a low-temperature reduction disintegration index (+3.15 mm)≥70%, and a reducibility≥75%.

12. The method according to claim 1, wherein:
the mixing is performed by an intensive mixer, a horizontal mixer, or a pan grinder.
